(19) United States
(12) Patent Application Publication
(10) Pub. No.: US 2009/0168628 A1
(43) Pub. Date: Jul. 2, 2009

(54) OPTICAL PICKUP APPARATUS

(75) Inventors: Masahiko Nishimoto, Osaka (JP); Naoki Nakanishi, Shiga (JP); Masayuki Ono, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 12/065,972

(22) PCT Filed: Mar. 8, 2007
(86) PCT No.: PCT/JP2007/054586

§ 371 Date: Mar. 6, 2008

(30) Foreign Application Priority Data
Mar. 30, 2006 (JP) 2006-096121

(51) Int. Cl. G11B 7/00; G11B 7/135

(52) U.S. Cl. 369/103; 369/112.03; 369/112.23; G9B/7; G9B/7.112

(57) ABSTRACT

An optical pickup apparatus for use with a semiconductor laser which outputs a light beam, the optical pickup apparatus has;
a diffraction grating for diffracting the light beam into diffracted light;
a collimator lens for rendering the diffracted light diffracted by the diffraction grating as a parallel beam;
an objective lens for focusing the parallel beam towards an optical information recording medium;
a hologram element for diffracting return light reflected from the optical information recording medium;
a plurality of light receiving elements for receiving the diffracted light diffracted by the hologram element; and
an incidence preventing area placed between the hologram element and the light receiving elements for, in the case where the light beam is focused on the recording surface on a side close to the objective lens out of recording surfaces of multilayer of the optical information recording medium, substantially preventing reflected light from the recording surface on a side remote from the objective lens from entering the light receiving elements.

### CROSS-REFERENCE TO RELATED APPLICATIONS

This application is a U.S. national phase application of PCT International Patent Application No. PCT/JP2007/054586 filed Mar. 8, 2007, claiming the benefit of priority of Japanese Patent Application No. 2006-096121 filed Mar. 30, 2006, all of which are incorporated by reference herein in their entirety.

### TECHNICAL FIELD

The present invention relates to an optical pickup apparatus having a function of detecting a reproduction signal and/or a recording signal and various servo signals which are used for an optical head apparatus as a key component of an optical information processing apparatus for performing processes such as recording, reproduction and erasure of information on optical information recording media including an optical disk.

### BACKGROUND ART

To record a high-resolution animation and information at present, it is necessary to increase a recordable capacity of one optical information recording medium. For that reason, providing multiple recording layers on the optical information recording medium is under consideration. There are reproduction-only optical information recording media such as a DVD-ROM and a DVD-Video, where a one-side two-layer recording type is commercially available. As for recording-only media, the optical information recording media of the one-side two-layer recording type are commercially available, such as a DVD-R DL (Dual Layer) and a DVDpositiveR DL (Dual Layer). In addition, the optical information recording media of the one-side two-layer recording and reproduction type are appearing as next-generation optical information recording media, such as a Blu-Ray Disc and an HD-DVD.

In the case of the optical information recording media having two recording layers, there is a problem of unwanted reflected light (stray light from another layer) from a recording layer other than the recording layer on which recording and/or reproducing of information is being performed. To be more precise, an accurate amount of light cannot be determined in the case where the light is detected with the light reflected by the recording layer on which recording and/or reproducing of information is being performed overlapping the light reflected by the recording layer other than the recording layer on which recording and/or reproducing of information is being performed.

As for such a problem, there is a proposal of a technique disclosed in Patent Document 1 for instance.

The entire disclosure of Japanese Patent Laid-Open No. 2005-203010 is incorporated herein by reference in its entirety.

Conventionally, an optical pickup apparatus shown in FIG. 2 has been considered. The following shows a principle of operation of the conventional optical pickup apparatus. FIG. 2 is a block diagram showing an optical principle of a general optical pickup apparatus 1 using a diffraction grating (hologram). Reference numeral 2 denotes a semiconductor laser as a light source, 3 denotes a polarized diffraction grating, 4 denotes a collimate lens, 5 denotes a quarter wavelength plate, 6 denotes an objective lens, 7 denotes an optical information recording medium, and 8 denotes a light receiving element group.

Emitted light from the light source 2 almost totally transmits through the polarized diffraction grating 3, converted to parallel light by the collimate lens 4, becomes circular light through the quarter wavelength plate 5, and is focused on the optical information recording medium 7 by the objective lens 6. The reflected light from the optical information recording medium 7 is redirected to a polarization direction orthogonal to the polarization direction of outgoing light by the quarter wavelength plate 5, and becomes converging light through the collimate lens 4 so as to enter the polarized diffraction grating 3. The reflected light in this case is the light orthogonal to the outgoing light, and so it is mostly diffracted by the polarized diffraction grating 3 so that positive primary diffracted light enters the light receiving element group 8 and the signal is detected. In this case, it is assumed that a track direction y of the optical information recording medium 7 is in a direction from a front face toward a backside of paper as shown. A tracking signal is detected as a Differential Push-Pull signal (DPP signal).

A problem arises when recording or reproducing for the optical information recording medium of two layers is performed with the optical pickup apparatus 1 using such a general diffraction grating 3. The two-layer optical information recording medium has two recording layers in a thickness direction of the medium. The first recording layer near the optical pickup apparatus 1 is composed of a half transparent recording layer. The optical pickup apparatus 1 switches a focus between the first recording layer and the second recording layer so as to perform recording or reproduction on both the layers.

A problem arises when detecting the tracking signal of such a two-layer optical information recording medium. To be more precise, a sub push-pull signal for tracking of the two-layer optical information recording medium is disturbed. This occurs because the reflected light from the other recording layer which is not focused on becomes defocused light and spreads out over a light receiving area of the light receiving element group 8.

FIG. 3 shows an instance thereof. FIG. 3 shows the instance when the light is focused on the first recording layer near the optical pickup apparatus 1 of the two-layer optical information recording medium. On the light receiving element group 8, the defocused light from the other off-focus layer (second recording layer) which is not focused on enters the light receiving area in addition to focused beams (indicated by black circles in FIG. 3 respectively) from the first recording layer which is focused on. Of the three beams, the defocused light of the main beam is strongly influential. In FIG. 3, it can be seen that the defocused light of the focusing main beam (defocused light of an Fo main beam) and the defocused light of the tracking main beam (defocused light of a Tr main beam) are incident astride each light receiving area. In FIG. 3, the former defocused light is indicated by a dotted semicircular area, and the latter defocused light is indicated by a dotted quarter-circular area. Of the light receiving areas generating SPP signals, much of the defocused light enters light receiving areas E and F.

As with the example shown in FIG. 3, when performing recording or reproduction on the first recording layer near the optical pickup apparatus 1, the push-pull signals due to a sub-beam may be generated only from output signals of light receiving areas G and H. Thus, the push-pull signals on the right and left of a sub-beam 1 are detected out of the three beams. In the case where the recording layer of the other layer is focused on, that is, when performing recording or reproduction on the second recording layer remote from the optical pickup apparatus 1, the push-pull signals due to the sub-beam may be generated only from output signals of light receiving areas E and F. Thus, the push-pull signals on the right and left of a sub-beam 2 are detected out of the three beams.

To be more specific, when recording or reproducing the two-layer optical information recording medium, if the differential push-pull signal DPP is generated by using only the push-pull signal of one of the two sub-beams corresponding to each of the layers, it is possible to detect the tracking signal without being influenced by the defocused light from the other layer. Such a method allows generation of the differential push-pull signal DPP and enables tracking even in the case where the optical information recording medium 7 is the two-layer optical information recording medium.

[Patent Document 1]: Japanese Patent Laid-Open No. 2005-203010

### DISCLOSURE OF THE INVENTION

However, the conventional optical pickup apparatus as shown in FIG. 2 generates the differential push-pull signal DPP by using only the push-pull signal of one of the two sub-beams. Therefore, the S/N ratio of the sub-beams is deteriorated, and a stable DPP signal cannot be generated on a boundary between a recorded area and an unrecorded area of the optical information recording medium. Furthermore, as the two sub-beams are selectively used, there arises a problem that a signal processing circuit becomes complicated.

Thus, in view of such a problem of the conventional optical pickup apparatus, the present invention provides the optical pickup apparatus which can accommodate the optical information recording medium of at least two layers and is capable of detecting a tracking error signal for realizing more accurate and stable recording and/or reproduction by using the signal processing circuit equivalent to a simple signal processing circuit previously used for the conventional apparatus, without the above-mentioned complicated signal processing circuit.

### MEANS TO SOLVE THE PROBLEMS

The 1^{st} aspect of the present invention is an optical pickup apparatus for use with a semiconductor laser which outputs a light beam, the optical pickup apparatus comprising:
a diffraction grating for diffracting the light beam into diffracted light;
a collimator lens for rendering the diffracted light diffracted by the diffraction grating as a parallel beam;
an objective lens for focusing the parallel beam towards an optical information recording medium;
a hologram element for diffracting return light reflected from the optical information recording medium;
a plurality of light receiving elements for receiving the diffracted light diffracted by the hologram element; and
an incidence preventing area placed between the hologram element and the light receiving elements for, in the case where the light beam is focused on the recording surface on a side close to the objective lens out of recording surfaces of multilayer of the optical information recording medium, substantially preventing reflected light from the recording surface on a side remote from the objective lens from entering the light receiving elements.

The 2^{nd} aspect of the present invention is the optical pickup apparatus according to the 1^{st} aspect of the present invention, wherein the diffraction grating diffracts the light beam into a zero-order diffracted light and a positive/negative primary diffracted light.

The 3^{rd} aspect of the present invention is the optical pickup apparatus according to the 2^{nd} aspect of the present invention wherein the incidence preventing area is integrally placed with the diffraction grating.

The 4^{th} aspect of the present invention is the optical pickup apparatus according to the 2^{nd} aspect of the present invention, wherein the incidence preventing area is a light shielding area.

The 5^{th} aspect of the present invention is the optical pickup apparatus according to the 4^{th} aspect of the present invention, wherein the light shielding area is formed by a material absorbing the reflected light from the recording surface on the side remote from the objective lens.

The 6^{th} aspect of the present invention is the optical pickup apparatus according to the 4^{th} aspect of the present invention, wherein the light shielding area is formed by a material reflecting the reflected light from the recording surface on the side remote from the objective lens.

The 7^{th} aspect of the present invention is the optical pickup apparatus according to the 6^{th} aspect of the present invention, wherein the material is a metal.

The 8^{th} aspect of the present invention is the optical pickup apparatus according to the 2^{nd} aspect of the present invention, wherein the incidence preventing area is formed by the diffraction grating having transmission efficiency of the zero-order diffracted light transmitting through the incidence preventing area substantially being 10% or less.

The 9^{th} aspect of the present invention is the optical pickup apparatus according to the 2^{nd} aspect of the present invention, wherein the recording surfaces of multilayer are recording surfaces of two-layer.

The optical pickup apparatus of the present invention accommodates the optical information recording medium of at least two layers and is capable of detecting a tracking error signal for realizing more accurate and stable recording and/or reproduction by using a signal processing circuit of a simpler configuration.

### BRIEF DESCRIPTION OF THE DRAWINGS

FIGS. 1(a) and 1(b) are schematic sectional views showing a configuration of a major portion of an optical system of an optical pickup apparatus according to an embodiment of the present invention;

FIG. 2 is a block diagram showing an optical principle indicating a conventional optical pickup apparatus; and

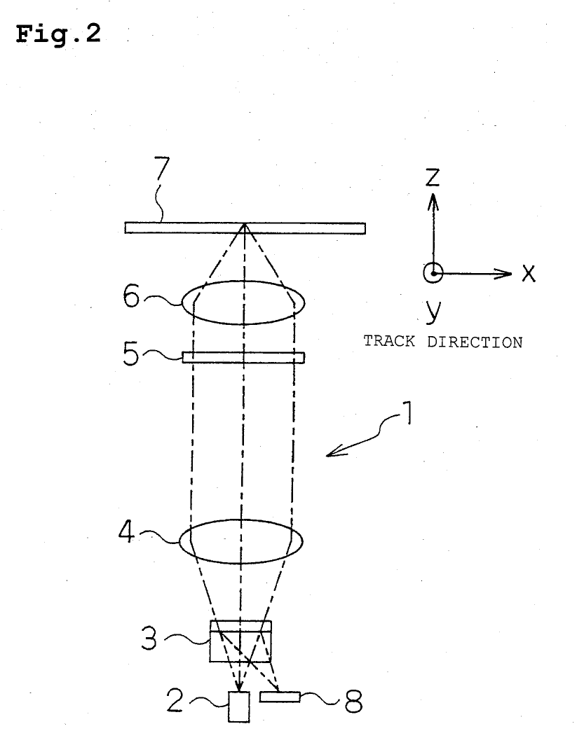

FIG. 3 is a plan view showing a conventional hologram division pattern and states of focused light and defocused light of a two-layer optical information recording medium.

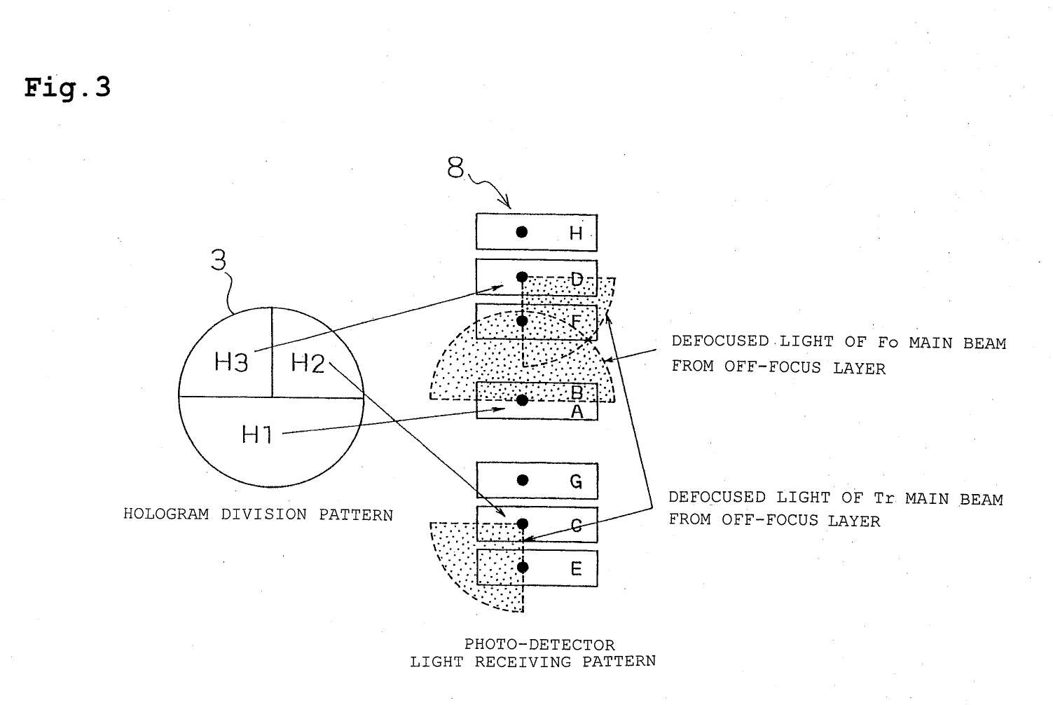

### DESCRIPTION OF SYMBOLS

1 General optical pickup apparatus
2 Semiconductor laser as a light source
3 Polarized diffraction grating
4 Collimate lens
5 Quarter wavelength plate
6 Objective lens
7 Optical information recording medium
8 Light receiving element group
101 Two-layer optical information recording medium
102 Semiconductor laser
103 Diffraction grating
104 Quarter wavelength plate
105 Polarized hologram element
106 First light receiving element group
107 Second light receiving element group
108 Third light receiving element group
109 Integrated circuit substrate
110 Substrate
111 Stray light elimination area
112 Collimator lens
113 Objective lens

### BEST MODE FOR CARRYING OUT THE INVENTION

Hereunder, an embodiment of the present invention will be described with reference to the drawings.

### Embodiment

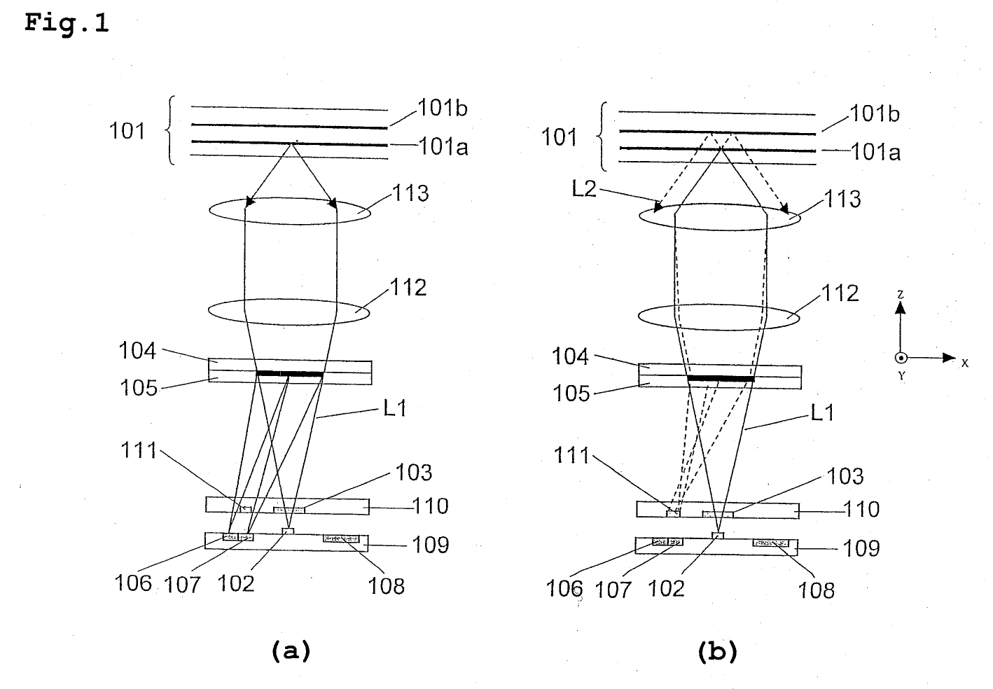

FIG. 1 schematically show a configuration of an optical pickup apparatus according to an embodiment of the present invention.

The optical pickup apparatus shown in FIG. 1 includes a semiconductor laser 102 for emitting a light beam L1 of a wavelength suited to recording and reproduction of a two-layer optical information recording medium 101, a diffraction grating 103 for diffracting the light beam L1 of the wavelength into a main beam of a zero-order diffracted light and a sub-beam of a positive/negative primary diffracted light (not shown), a quarter wavelength plate 104 for polarizing the light beam L1 which is linear polarized light (p-polarized light) to circular light, and a polarized hologram element 105 for diffracting the light beam L1 reflected from the two-layer optical information recording medium 101. The optical pickup apparatus also includes an integrated circuit substrate 109 having a first light receiving element group 106 for receiving the diffracted light from the polarized hologram element 105, a second light receiving element group 107 and a third light receiving element group 108 configured on the same substrate. A substrate 110 forming the diffraction grating 103 has a stray light elimination area 111 integrally formed with the diffraction grating 103 thereon. Furthermore, a collimator lens 112 and an objective lens 113 are provided between the quarter wavelength plate 104 and the two-layer optical information recording medium 101. The first light receiving element group 106 and the second light receiving element group 107 are the light receiving element groups for generating tracking error signals, and the third light receiving element group 108 is the light receiving element group for generating focus error signals.

The stray light elimination area 111 is formed by the diffraction grating having depth of a concave portion on its bumpy surface adjusted so that transmission efficiency of the zero-order diffracted light transmitting through the stray light elimination area substantially becomes 10% or less. Here, as for the reason for defining “substantially 10% or less,” it is defined as “substantially 10% or less” in consideration of manufacturing variations even though it is technically possible to hold down the transmission efficiency of the zero-order diffracted light at 5% or less by controlling the depth of the concave portion. If transmission efficiency can be held down at 10% or less, stray light is substantially blocked so that it becomes possible to detect a tracking error signal for realizing more accurate and stable recording and reproduction by using a simpler signal processing circuit.

It is thus possible to integrally form the stray light elimination area 111 and the diffraction grating 103 and thereby shape both of them at the same time. Therefore, there is an advantage that man-hours in manufacturing process can be reduced in comparison with the case of separately forming a film of a reflective material such as a metal described later as the stray light elimination area.

FIG. 1(a) shows the process in which the light beam L1 emitted from the semiconductor laser 102 converges on a first recording layer 101a of the two-layer optical information recording medium 101 and the light beam L1 reflected from the first recording layer 101a consequently enters the first and second light receiving element groups 106 and 107. FIG. 1(b) shows the process until the light beam L1 emitted from the semiconductor laser 102 converges on a first recording layer 101a of the two-layer optical information recording medium 101 in full line, and shows the process until the light beam L2 reflected from the second recording layer 101b enters the stray light elimination area 111 in broken line.

Next, operation of the optical pickup apparatus of this embodiment will be described.

First, in the case of reproducing or recording the two-layer optical information recording medium 101, the semiconductor laser 102 is driven, and the light beam L1 (indicated in full line in FIG. 1) emitted from the semiconductor laser 102 is diffracted by the diffraction grating 103 into the main beam of the zero-order diffracted light and the sub-beam of the positive/negative primary diffracted light (not shown). As the diffracted light is the p-polarized light, approximately 100% of the zero-order light transmits through the polarized hologram element 105 so that the p-polarized light beam L1 becomes the circular light at the quarter wavelength plate 104. The circular light converges on the first recording layer 101a of the two-layer optical information recording medium 101 through the collimator lens 112 and the objective lens 113 and is reflected so as to enter the quarter wavelength plate 104 through the objective lens 113 and the collimator lens 112 again. That incident light becomes s-polarized light and enters the polarized hologram element 105 which is a light beam branching instrument. And the incident light is diffracted into the positive/negative primary diffracted light by the polarized hologram element 105. The ratio to be diffracted is 20 to 40% or so.

The light beam L1 reflected by the first recording layer 101a of the two-layer optical information recording medium 101 is diffracted in the X direction in FIG. 1 by the polarized hologram element 105. And the positive/negative primary diffracted light is led to the first light receiving element group 106, the second light receiving element group 107 and the third light receiving element group 108.

The light beam L2 (stray light represented in broken line in FIG. 1(b)) not reflected by the first recording layer 101a of the two-layer optical information recording medium 101 and transmitted is reflected by the second recording layer 101b. And the reflected light enters the quarter wavelength plate 104 through the objective lens 113 and the collimator lens 112 again. The light becomes s-polarized light and enters the polarized hologram element 105 which is the light beam branching instrument. And the incident light is diffracted into the positive/negative primary light by the polarized hologram element 105. Here, the angle by which the light beam L2 of the stray light enters the polarized hologram element 105 is different from an incident angle of the light beam L1, and so a diffraction angle is different from the case of L1. To be more specific, the light beam L2 reflected by the second recording layer 101b of the two-layer optical information recording medium 101 is diffracted in the X direction in FIG. 1 by the polarized hologram element 105 so that positive primary diffracted light enters the stray light elimination area 111. This lowers the ratio at which the light beam L2 is led to the first light receiving element group 106 and the second light receiving element group 107.

The light beam L2 (stray light) reflected by the second recording layer 101b of the two-layer optical information recording medium 101 is mostly eliminated in the stray light elimination area 111 so that it does not substantially enter the light receiving element groups 106 and 107. A signal of the light beam L1 from the first recording layer 101a is led to the light receiving element groups 106 and 107. Thus, it is possible to obtain an accurate and stable tracking error signal.

In the above embodiment, a description has been given as to the case where the stray light elimination area 111 as an example of an incidence preventing area of the present invention is integrally placed with the diffraction grating 103 on the same substrate 110. However, it is not limited thereto, but they may also be separately placed. In short, the stray light elimination area may be placed anywhere between the polarized hologram element 105 and the light receiving element groups 106 and 107.

In the embodiment, a description has been given as to the case where the stray light elimination area 111 as an example of the incidence preventing area of the present invention is formed by the diffraction grating so that the transmission efficiency of the zero-order diffracted light transmitting through the stray light elimination area substantially becomes 10% or less. However, it is not limited thereto. In short, it is sufficient to be able to substantially block the stray light entering the light receiving element, and there is no need to be formed by the diffraction grating in the first place. Here, “able to substantially block” is not limited to the case of completely blocking the stray light. It is sufficient, for instance, to block the stray light to the extent that those skilled in the art can determine the advantage of the present invention to be achievable. The meaning of “able to substantially block” also covers such an extent.

The embodiment has also described the case where the stray light elimination area 111 is the diffraction grating. However, it is not limited thereto. For instance, the stray light elimination area 111 may also be formed by a light-shielding substance, and the light-shielding substance may be a substance absorbing the stray light, a substance reflecting the stray light or a metal. Here, carbon black can be named as an example of the substance absorbing the stray light, gold can be named as an example of the substance reflecting the stray light, and aluminum can be named as an example of the metal.

The embodiment has also described the case of having a two-layer recording surface as an example of a multilayer recording surface of the optical information recording medium. However, it is not limited thereto. For instance, the optical information recording medium may have a recording surface of three or more layers. Even in that case, the same effect as in the case of two layers can be exerted.

The embodiment has also described the case where the optical pickup apparatus of the present invention has a configuration for handling the optical information recording medium capable of recording and reproduction. However, it is not limited thereto. For instance, the optical pickup apparatus may be capable of only recording or only reproduction.

The embodiment has also described the case where the quarter wavelength plate 104 and the polarized hologram element 105 are placed in almost the same position. However, it is not limited thereto. For instance, the quarter wavelength plate 104 may also be placed between the objective lens 113 and the collimator lens 112.

The embodiment is ready for the optical information recording medium of at least two layers. In addition, the embodiment is capable of detecting the tracking error signal for realizing more accurate and stable recording and reproduction, not by using the complicated signal processing circuit disclosed in Patent Document 1, but by using the signal processing circuit equivalent to the simpler signal processing circuit used for the conventional apparatus before then.

The optical pickup apparatus according to the present invention is useful as an optical pickup apparatus ready for the optical information recording medium of at least two layers and capable of detecting a tracking error signal for realizing more accurate and stable recording and/or reproduction by using a signal processing circuit of a simpler configuration.

1. An optical pickup apparatus comprising:
a semiconductor laser for outputting a light beam;
a diffraction grating for diffracting the light beam into diffracted light of a different order;
a collimator lens for rendering the diffracted light diffracted by the diffraction grating as a parallel beam;
an objective lens for focusing the parallel beam on a recording surface of an optical information recording medium;
a hologram element for diffracting return light reflected from the optical information recording medium;
a plurality of light receiving elements for receiving the diffracted light diffracted by the hologram element; and
an incidence preventing area placed between the hologram element and the light receiving elements for, in the case where the light beam is focused on the recording surface on a side close to the objective lens out of recording surfaces of multilayer of the optical information recording medium, substantially preventing reflected light from the recording surface on a side remote from the objective lens from entering the light receiving elements.

2. The optical pickup apparatus according to claim 1, wherein the diffraction grating diffracts the light beam into a zero-order diffracted light and a positive/negative primary diffracted light.

3. The optical pickup apparatus according to claim 2, wherein the incidence preventing area is integrally placed with the diffraction grating.

4. The optical pickup apparatus according to claim 2, wherein the incidence preventing area is a light shielding area.

5. The optical pickup apparatus according to claim 4, wherein the light shielding area is formed by a material absorbing the reflected light from the recording surface on the side remote from the objective lens.

6. The optical pickup apparatus according to claim 4, wherein the light shielding area is formed by a material reflecting the reflected light from the recording surface on the side remote from the objective lens.

7. The optical pickup apparatus according to claim 6, wherein the material is a metal.

8. The optical pickup apparatus according to claim 2, wherein the incidence preventing area is formed by the diffraction grating having transmission efficiency of the zero-order diffracted light transmitting through the incidence preventing area substantially being 10% or less.

9. The optical pickup apparatus according to claim 2, wherein the recording surfaces of multilayer are recording surfaces of two-layer.
